(19) United States
(12) Patent Application Publication
(10) Pub. No.: US 2018/0137562 A1
(43) Pub. Date: May 17, 2018

(54) PROCESSING FOR REQUIREMENT REQUESTS

(71) Applicant: Acquisition Simplicity, LLC, Liberty Lake, WA (US)

(72) Inventor: Shane Criddle, Liberty Lake, WA (US)

(21) Appl. No.: 15/870,124

(22) Filed: Jan. 12, 2018

Related U.S. Application Data
(63) Continuation of application No. 15/162,956, filed on May 24, 2016.

(51) Int. Cl. G06Q 30/08; G06Q 30/06; G06F 17/30

(52) U.S. Cl. CPC G06Q 30/08; G06Q 30/0633; G06F 17/3053

(57) ABSTRACT

Techniques to enable requestors to select vendors for fulfilling requirements of the requestors for items are described herein. In some instances, an interface may provide a requestor with options regarding items available for purchase, and the requestor may specify requirements for items using these options. The requirements may be sent to vendors and the vendors may indicate an ability to fulfill the requirements and/or a cost to fulfill the requirements. The vendors may be ranked based on their ability to fulfill the requirements and/or the costs to fulfill the requirements and the rankings may be provided to the requestor via the interface. The interface may also allow the requestor to inform one of the vendors about an interest of the requestor in purchasing items from the vendor.

### CROSS REFERENCE TO RELATED APPLICATIONS

This is a continuation application which claims priority to commonly assigned, co-pending U.S. patent application Ser. No. 15/162,956, filed May 24, 2016. application Ser. No. 15/162,956 is fully incorporated herein by reference.

### BACKGROUND

Businesses that rely on technology routinely order new equipment and services. The process of ordering the equipment and services often involves filling out a request for proposal (RFP), a request for information (RFI), and/or a request for a quotation (RFQ). These RFP's, RFI's, and RFQ's are used to receive bids from a plurality of vendors interested in providing the equipment or services to the businesses. Filling out these requests can be time consuming as well as confusing. Different departments of a business may have separate requirements, and thus, need different types of equipment. Additionally, individuals that work for the vendors or “bidders” typically have some sort of a relationship with individuals that work for the businesses, or “requestors.” These relationships can interfere with the bidding process and the requestor does not always necessarily get the best price available. For example, the requestor may just purchase equipment or services from a bidder that they have purchased from before.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1. illustrates an example architecture in which techniques described herein may be implemented.

FIG. 2A-2C illustrate example interfaces that may be presented to enable a requestor to define requirements for a request.

FIG. 3 illustrates an example interface that may be presented to a vendor to enable the vendor to indicate an ability to fulfill a request.

FIG. 4 illustrates an example interface that may be presented to display a ranking of a plurality of vendors.

FIG. 5 illustrates an example interface that may be presented to a requestor to enable the requestor to select a vendor for purchasing items.

FIG. 6 illustrates an example interface displaying a vendor library.

FIG. 7 illustrates an example interface to enable users associated with an acquisition service to enter and/or organize information regarding items available for purchase.

FIG. 8 illustrates an example process to enable a requestor to select a vendor for fulfilling requirements of the requestor for items.

### DETAILED DESCRIPTION

As discussed above, current techniques used by businesses for ordering new equipment or services is inefficient, inaccurate, and/or biased. For example, most hospitals have many different departments (e.g., emergency department, cardiology, intensive care unit, pediatric department, neurology, oncology, gynecology, maternity, etc.). Every department may need different types of equipment to operate. This equipment may vary in networking capabilities, security options, licensing options, interfacing capabilities, remote access capabilities, etc. Receiving and organizing all of the requirement needs for each department can be time consuming and redundant. Additionally, with the state of technology always evolving and progressing, often times hospitals do not know about new equipment or new functionality of the equipment. In fact, some businesses may simply file an RFP from a previous year. This can result in an inaccurate budget proposal which may cause financial harm to a business. Furthermore, quite often representatives from a bidder may have a relationship with a representative from a requestor due to a previous transaction. This may result in the requestor purchasing items from the bidder due to their relationship as opposed to purchasing items based on the requirements of the requestor that the bidder is able to fulfill, as well as the bidder's price.

This disclosure describes an acquisition service platform to enable requestors to select vendors for fulfilling requirements of the requestors for items. The acquisition platform may provide tools to enable requestors to specify requirements regarding items that are needed by the requestors. Items may include equipment, services, etc. The acquisition platform may provide tools to enable vendors to view requirements of requestors regarding items and to specify an ability to fulfill those requirements. Further, the acquisition service platform may provide tools to rank vendors for fulfillment of requirements and provide the ranking to requestors and other parties. Moreover, the acquisition service platform may provide other tools.

In one illustration, the acquisition service platform may provide an interface to enable a requestor, such as a business, organization, individual, etc., to specify requirements for items the requestor in interested in acquiring. For example, the interface may enable individuals associated with different departments of a business to specify their own specific requirements regarding equipment they use or equipment that seek to use. Once the requirements are received from the requestor, the acquisition service platform may create a request for a vendor.

The acquisition service platform may provide an interface to enable a vendor to indicate an ability to fulfill requirements set forth by a requestor regarding a request. For example, the interface may display to the vendor a list of the requirements determined by the requestor, and provide an option to indicate if they are able to fulfill the requirement in full, partially full, or not at all. Through the interface, the vendor may also specify a cost for providing such item to the requestor (e.g., a bid on for purchasing an item). In many instances, multiple vendors may provide information regarding their ability to fulfill requirements set forth by a requestor and/or a cost for providing an item.

Upon receiving information from vendors, the acquisition service platform may rank vendors according to an ability of the vendors to fulfill requirements, costs for acquiring items from the vendors, etc. For example, a vendor that is able to fulfill more requirements and/or offers a lower overall cost for items may rank higher than another vendor that is able to fulfill less requirements and/or offers a higher overall cost for items. In some instances, the requirements and/or costs may be weighted. The ranking may be provided to the requestor. The requestor may select a vendor to actually fulfill the requirements. In some instances, the acquisition service platform may send a communication to the selected vendor indicating an interest of the requestor in acquiring items from the vendor (e.g., indicating that a bid from the vendor has been selected). Further, in some instances, a communication may be sent to vendors that were not selected indicating that the vendors were not selected.

This brief introduction is provided for the reader's convenience and is not intended to limit the scope of the claims. Furthermore, the techniques described in detail below may be implemented in a number of ways and in a number of contexts. Example implementations and contexts are provided with reference to the following figures, as described below in more detail. However, the following implementations and contexts are but some of many.

### Example Architecture

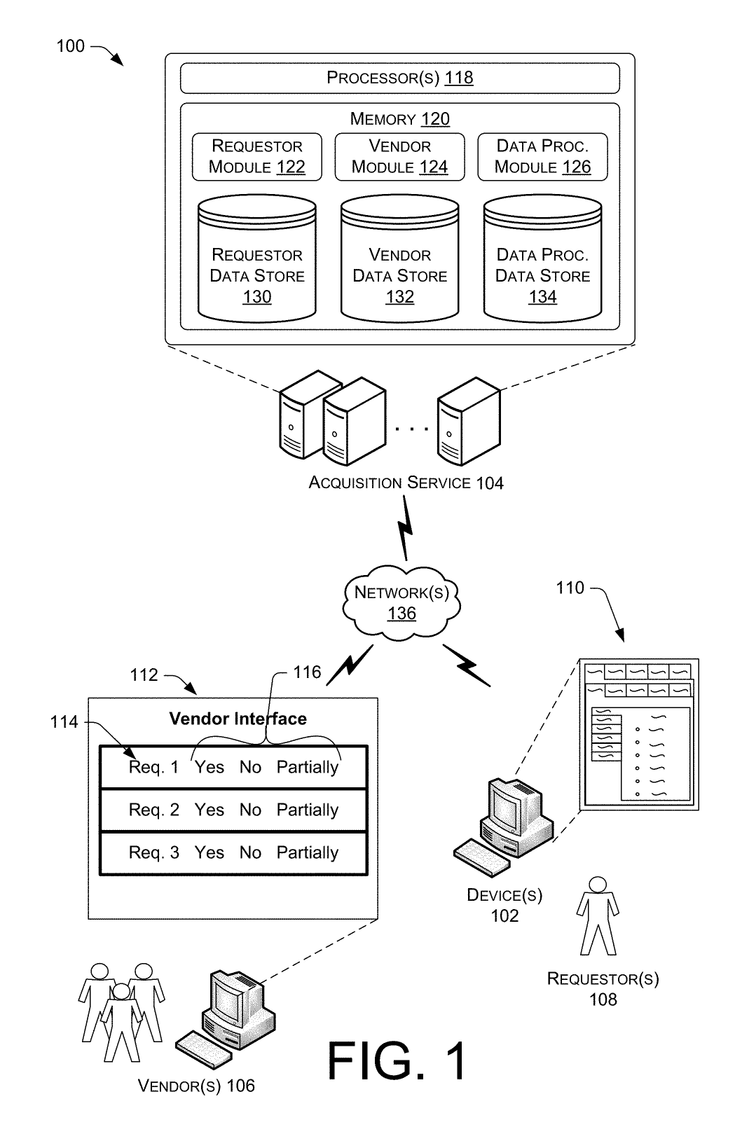

FIG. 1 illustrates an example architecture 100 in which techniques described herein may be implemented. The architecture 100 includes one or more devices 102 (hereinafter “the device 102”) configured to communicate with an acquisition service 104 and/or one or more vendors 106 (hereinafter “vendor 106”) to facilitate an acquisition. A vendor may be any party that supplies items. In some instances, a vendor may be referred to as a merchant or seller. Vendors include manufacturers, distributors, etc. As illustrated, the vendor 106 may be associated with a computing device. The device 102 may enable a requestor 108 to fill out a request through an interface 110 that is presented on device 102. A requestor may include an individual, such as any individual associated with a company, organization, entity, and so on. For example, a requestor may include IT people, business individuals, other employees (e.g., doctors, nurses, etc.), and so on. Through interface 110 the requestor 108 may login to an account, create an account, create a new request, access unfinished requests, access completed requests, access inactive requests, and so on. When the requestor 108 accesses unfinished requests or creates a new request, interface 110 may provide the requestor 108 with options to select requirements for a request, such as a Request for Information (RFI), Request for Proposal (RFP), or a Request for Quotation (RFQ). Once the request is filled out, the requirements may be presented to the vendor 106 on a vendor interface 112. The vendor interface 112 may enable the vendor 106 to indicate whether or not they are able to fulfill the requirements determined by the requestor 108 as well as provide a bid price for items and other information. For example, as illustrated in FIG. 1, the vendor interface 112 may provide a requirement 114 (“Req. 1”) and options 116 to indicate an ability to fulfill the requirement 114. Once the vendor 106 has provided information, that information is processed by the acquisition service 104 and vendors are ranked based on their ability to fulfill the requirements, their bid price, and/or any other information. The ranking may then be displayed on the interface 110 for the requestor 108. The acquisition service 104 may then receive a selection from the requestor 108 indicating a vendor from which they would like to purchase items. An item may comprise a tangible item (e.g., equipment, devices, etc.) or a service. An acquisition of an item may include purchasing the item, renting the item, borrowing the item, and so on.

As noted above, in many instances a request may be associated with one or more requirements for acquiring items. For example, a hospital may be interested in purchasing new equipment including computers, servers, beds, medical devices (e.g., defibrillators, heart monitors, etc.), and so on. Here, the hospital may specify a set of requirements in a request. The requirements may specify the types of computers, servers, beds, medical devices, and so on that the hospital may require to run its business. In particular, in this example, the hospital may specify that 100 touch screen tablet computers are needed that have a particular processing speed, 10 servers are needed that satisfy particular security measures, 50 new heart monitors are needed that have particular features, and so on. In another example, a business may specify requirements for a laundry service, such as how many pieces of clothing will be picked-up, how often cleanings will be needed, how quickly clothing needs to be returned, and so on.

The device 102 and/or the computing device associated with the vendor 106 may comprise a laptop computer, a desktop computer, a smart phone, an electronic reader device, a mobile handset, a personal digital assistant (PDA), a portable navigation device, a portable gaming device, a tablet computer, a watch, a portable media player, and the like. In some instances, the device 102 and/or the computing device associated with the vendor 106 may be referred to as a mobile device, indicating that the device 102 and/or the computing device associated with the vendor 106 is portable. In some instances, a mobile device includes any of the examples listed above except for the desktop computer.

The device 102 and/or the computing device associated with the vendor 106 may be equipped with one or more processors and memory, one or more interfaces (e.g., a communication interface(s) (network interface(s)), an input/output interface(s), etc.), one or more displays, one or more sensors, etc. The one or more processors may include a central processing unit (CPU), graphics processing unit (GPU), a microprocessor, and so on. The one or more displays may include a Liquid-crystal Display (LCD), a Light-emitting Diode (LED) display, an organic LED display, a plasma display, an electronic paper display, or any other type of technology. The one or more sensors may include a proximity sensor that detects a proximity of objects to the device, an infrared (IR)/thermal sensor, a Wi-Fi® sensor, a Bluetooth® sensor, a camera, a microphone, an accelerometer, a compass, a gyroscope, a magnetometer, a Global Positioning System (GPS), a depth sensor, an olfactory sensor (e.g., for smell), or other sensor. The memory may include a client application (e.g., module) configured to interface with an individual (e.g., the requestor 108, the vendor 106, etc.) and perform other functionality. For instance, the client application may output an interface (e.g., the interface 110, the vendor interface 112, etc.) to receive input from an individual, provide information, and perform a variety of other operations. The client application may operate in cooperation with the acquisition service 104. In some instances, the client application comprises a browser, application (e.g., desktop application, mobile application, etc.), and so on. The device 102 and/or the computing device associated with the vendor 106 may be associated with an input/output device, such as a keyboard, mouse, trackpad, monitor, speaker, printer, and so on.

The acquisition service 104 may include one or more computing devices, such as one or more desktop computers, laptop computers, servers, and the like. The one or more computing devices may be configured in a cluster, data center, cloud computing environment, or a combination thereof. In one example, the one or more computing devices provide cloud computing resources, including computational resources, storage resources, and the like, that operate remotely to the device 102 and/or the vendor 106.

The one or more computing devices of the acquisition service 104 may include one or more processors 118 and memory 120. Although not illustrated, the one or more computing devices of the acquisition service 104 may include one or more interfaces (e.g., a communication interface(s) (network interface(s)), an input/output interface(s), etc.). The memory 120 may include software functionality configured as one or more “modules.” The term “module” is intended to represent example divisions of the software for purposes of discussion, and is not intended to represent any type of requirement or required method, manner or organization. Accordingly, while various “modules” are discussed, their functionality and/or similar functionality could be arranged differently (e.g., combined into a fewer number of modules, broken into a larger number of modules, etc.). Further, while certain functions and modules are described herein as being implemented by software and/or firmware executable on a processor, in other embodiments, any or all of the modules may be implemented in whole or in part by hardware (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.) to execute the described functions. As illustrated in FIG. 1, the memory 120 includes a requestor module 122, a vendor module 124, and a data processing module 126.

The requestor module 122 may generally manage requests made by the requestor 108. The requestor module 122 may provide the interface 110 to the requestor 108 (e.g., including a list of selectable requirements regarding items available for purchase), receive selection of one or more of the requirements from the requestor 108 via the interface 110, generate a request for the vendor 106 based on the selection of the one or more requirements from the requestor 108, and so on. The requestor module 122 may also allow the requestor 108 to indicate a degree of importance for one or more of the selectable requirements. This degree of importance may be indicated using a selectable 1-10 scale that is next to the selectable requirement on the interface, using a text input field, and so on. The requestor module 122 may also save and maintain unfinished requests or inactive requests that the requestor 108 can access at a later point in time. These saved requests may be stored in a requestor data store 130.

The requestor module 122 may also maintain information regarding items available for purchase (e.g., a library of items that are available for purchase). This information may have been collected from vendors (e.g., from websites associated with the vendors, by calling vendors, etc.). The information may be provided by the requestor module 122 to the requestor 108 so that the requestor 108 can make a request based on what is currently available in the marketplace. For instance, the requestor module 122 may provide the requestor 108 with information that indicates which vendors are providing what items and/or specific details of the items (e.g., technical details of equipment that is available).

The vendor module 120 may generally manage information provided to the vendor 106 and/or information received from the vendor 106. For example, the vendor module 120 may provide information regarding requests received from the requestor 108 to the vendor 106 via the vendor interface 112. This information may include the requirements indicated by the requestor 108 and/or options (e.g., graphical elements) that allow the vendor 106 to indicate whether or not they are able to fulfill such requirements, a price for fulfilling a particular requirement, and so on. Additionally, or alternatively, the vendor interface 112 may allow the vendor 106 to provide a written explanation regarding their capability of fulfillment.

The data processing module 126 may process the information received by the requestor 108 and/or the information received by the vendor 106 and generate a ranking of vendors based on that information. For instance, the data processing module 126 may take into account the requirements indicated by the requestor 108, the degree of importance of those requirements as indicated by the requestor 108, the indications from the vendors of their capability to fulfill the requirements of the requestor 108, and/or the bid price received form the vendors to generate a ranked list of the vendors. In some instances, the degree of importance on requirements may be used to weight the requirements for the ranking (e.g., rank a vendor higher than another vendor, when the vendor is able to fulfill a requirement that is associated with a relatively high degree of importance and the other vendor is not able to fulfill the same requirement). Further, in some instances the ranking includes a multi-factor approach that weights pricing and/or requirements differently. A ranked list of vendors may be provided to the requestor 108 along with a variety of information. A few examples of the types of information that may be provided to the requestor 108 include:
The name of the vendors.
The percent of requirements that each vendor can fulfill (e.g., vendor A can satisfy 90% of the requirements).
An indication of pass, partially pass, or fail, for each vendor based on the percent of requirements that the respective vendor can fulfill.
A bid price provided by each vendor (e.g., a total bid price, a price per item, a price to fulfill a particular requirement, etc.).
An overall indication of the vendor's ability to fulfill the requirements and/or an indication for individual requirements.

As illustrated in FIG. 1, the acquisition service 104 may include the data stores 130-134. The requestor data store 130 may store request data received from the device 102 (e.g., data regarding requests RFIs, RFPs, RFQs, etc.). The request data may be collected overtime from a plurality of devices as requestors of those devices make requests through the plurality of devices. Some example request data may include:
The name of the project, health system, facility name, or category type.
Networking requirements, such as requirements for hard wired networking requirements, wireless networking requirements, telemetry requirements, etc.
Server requirements, such as requirements for virtual servers, physical servers, requestor provided servers, or vendor provided servers.
Security requirements, such as what types of security a requestor requires for networking services, storage services, etc.
Licensing requirements, such as requirements related to licenses of items, individual license options, unlimited sharing of data between department's options, or lifetime software upgrade options.
Interfacing requirements, such as requirements for interface capabilities between devices.
Remote access requirements, such as a requirements regarding a type of data being accessed and/or an amount of storage needed.
Etc.

In some instances, the requestor data store 130 may save unfinished requests or inactive requests that may be accessed by the requestor 108. An unfinished request may be a request in which all of options are not completed by a requestor (e.g., a requestor has not yet identified requirements for the IT department, but has identified requirements for the emergency room department). An inactive request may be a request in which some requirements are specified, such as in a case where a list of vendors have been ranked and provided to the requestor 108, but the request has not yet been fulfilled (e.g., perhaps for financial reasons, timing, etc.).

In some instances, the request data includes account information. The account information may include information about a financial account of the requestor from which to pull funds when an acquisition is processed. The account information may also include other types of information that the requestor has registered with the acquisition service 104, such as login information and so on.

The vendor data store 132 may store vendor information of vendors that have registered with the acquisition service 104 and/or otherwise provided information to the acquisition service 104 or another service. The vendor information may include the name of the vendor, the location of the vendor, the types of items that the vendor provides (e.g., offers for acquisition), and/or specific details about the items the vendor provides. Further, the vendor data may include information regarding fulfillment of requests, such as information indication an ability of a vendor to fulfill a request from a requestor.

The memory 120 (as well as all other memory described herein) may include computer storage media (e.g., computer-readable storage media). Computer storage media includes volatile and non-volatile, removable and non-removable media implemented in any method or technology for storage of information, such as computer readable instructions, data structures, program modules, or other data. Computer storage media includes, but is not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include communication media, such as modulated data signals and carrier waves. As such, computer storage media is limited to non-transitory media.

The architecture 100 may also include one or more networks 136 to enable the device 102, the acquisition service 104, and/or the vendor 106 to communicate with each other. The one or more networks 136 may include any one or combination of multiple different types of networks, such as cellular networks, wireless networks, Local Area Networks (LANs), Wide Area Networks (WANs), and the Internet.

### Example Interfaces

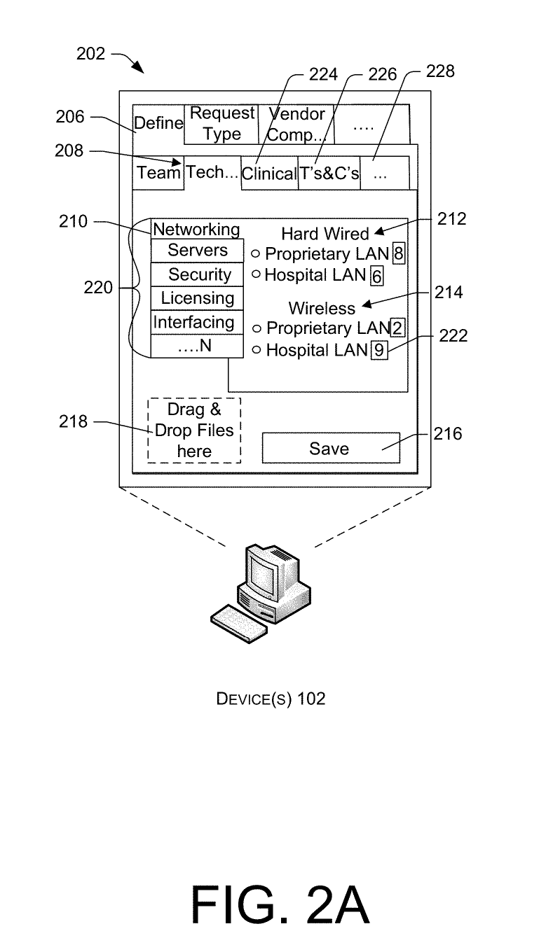

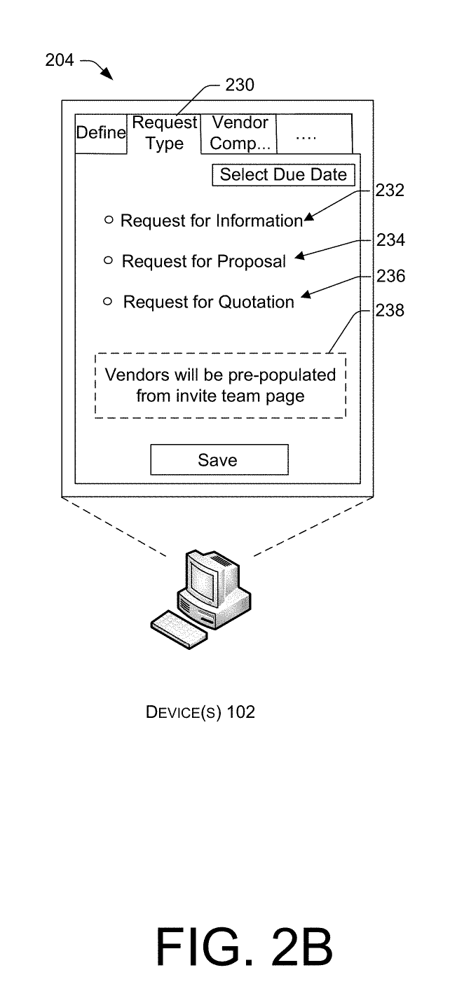

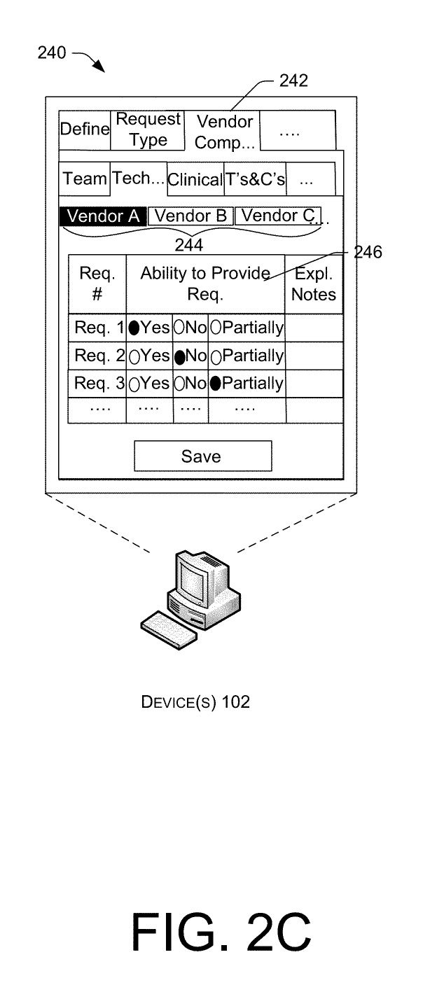

FIGS. 2-5 illustrate example interfaces that may be presented to a requestor or to a vendor to facilitate the requesting techniques discussed herein. The interfaces may be displayed through a browser, an application (e.g., a client application), and so forth.

FIG. 2A illustrates interface 202 that may be presented to enable a requestor to specify requirements in a request. In this example, requirement options are presented when a define tab 206 (and a technology tab 208 under the define tab 206) is selected. Although the requirement options may be presented in other tabs. Under the technology tab 208, the requestor is provided with a plurality of requirement options to select requirements for a request. For instance, in the example used in FIG. 2A, these requirement options may pertain to networking, servers, security, licensing interfacing, or any number of requirements (e.g., remote access, test environments, project management, etc.). These requirement options may be presented as tabs, as illustrated by a networking tab 210. When a requestor selects one of the requirement tabs, a list of selectable requirement options may be presented to the user. In FIG. 2A, the requestor has selected the networking tab 210, and may select hard wired requirements 212, wireless requirements 214, etc. Additionally, or alternatively, a requestor may drag and drop files with requirement option information into a drag & drop file box 218 to specify requirements for a request.

Once requirements on the networking tab 210 have been filled out, the requestor may select the save button 216. The interface 202 may then provide an indication to the requestor if all (or more than a threshold number) of the requirement options on the networking tab 210 were specified. For instance, the networking tab 210 may then turn green if available requirement options are specified. Alternatively, if partially filled out (e.g., more than one threshold and less than another), the networking tab 210 may turn yellow. Further, if not filled out (e.g., less than a threshold, no options are selected, etc.), the networking tab 210 may be red. Tabs in the interface 202 may be red before they have been selected or filled out. The requestor may select (e.g., click) on any one of a plurality of tabs 220 to specify requirements in a similar fashion as done with respect to the networking tab 210. Each tab may have a different set of requirement options, such as requirement options that are associated with different categories. Further, a level of completeness of each tab may be indicated (e.g., with red, yellow, and green colors).

In some instances, a requirement option may be presented with an option to specify a degree of importance. As illustrated, an input field 222 may be located next to a requirement option so that an individual may specify a degree of importance (e.g., a weight factor) for that requirement. Although other types of graphical elements may be used, such as a drop down menu.

As illustrated, the interface 202 includes other tabs within the define tab 206. For example, the define tab 206 may also include a clinical tab 224 with selectable requirement options regarding types of monitors, number of monitors, size of monitors, and any other functionality regarding monitors. Further, the define tab 206 may include a terms and conditions tab 226 in which a requestor may specify requirements regarding terms and conditions of a purchase. These terms and conditions may be uploaded (e.g., using a drag and drop operation). The define tab 206 may also include any number of tabs, illustrated with element 228. Other tabs may include a service and support tab, an education tab, or a legal tab, which may include selectable requirement options regarding their respective subject matter. The user may click on any tab within the define tab 206 to specify requirements for items (e.g., equipment) desired for purchase. The tabs 208, 224, 226, 228, and/or any other tab may indicate a level of completeness of requirement options associated with the tab, in a similar manner (or different manner) as that discussed above (e.g., showing different colors for different levels of completeness).

In some instances, individuals may be given access to different tabs. For example, each of the tabs 208, 224, 226, and 228 may be associated with a different category or department within an organization (e.g., a company). Different individuals may then be given access to different tabs. For instance, in a hospital setting, the intensive care unit, coronary care unit, emergency department, pre-operative unit, post-operative unit, post-anesthesia care unit, labor and delivery unit, neonatal intensive care unit, and any other unit may independently fill out a section of any tab to indicate their requirements for items. In particular, an individual that works in the intensive care unit may be given access to an intensive care tab to specify requirements for the intensive care unit (e.g., specify equipment needed by that unit). In another example, an individual that works in the IT department may be given access to specify requirements related to the IT department. The access ability of individuals may be determined by an access level granted to each individual. Furthermore, the requirements that the individual is allowed to specify may be indicated by the interface 110. For example, requirements that the individual is allowed to specify may be highlighted.

FIG. 2B illustrates interface 204 that may enable a requestor to specify a type of request to send to a vendor. This may be performed under a request type tab 230. The requestor may be enabled to indicate that the request is (i) a request for information by selecting the request for information option 232, (ii) a request for proposal by selecting the request for proposal option 234, or (iii) a request for quotation by selecting the request for quotation option 236. Additionally, the requestor may specify (e.g., invite) a vendor to receive a request, such as through a box 238 (which may show any vendors that may have been previously invited to receive a request). The requestor may be given the option to set a due date for the request as well as the option to save information selectable on the request type tab 230. Once saved, as described above, the tab may turn green, yellow, or remain red depending on the level of completeness of the tab.

FIG. 2C illustrates interface 240 that may enable a requestor to compare the ability of vendors to fulfill requirements indicated by the requestor. For instance, under a vendor comparison tab 242, a requestor may select from any one of vendors 244 and the interface 240 will present a table, such as table 246, that displays a list of the requirements specified by the requestor, information indicating an ability of a selected vendor to fulfill the requirements, explanatory notes provided by the vendor, and so on. This may allow the requestor to select an appropriate vendor to fulfill a purchase request.

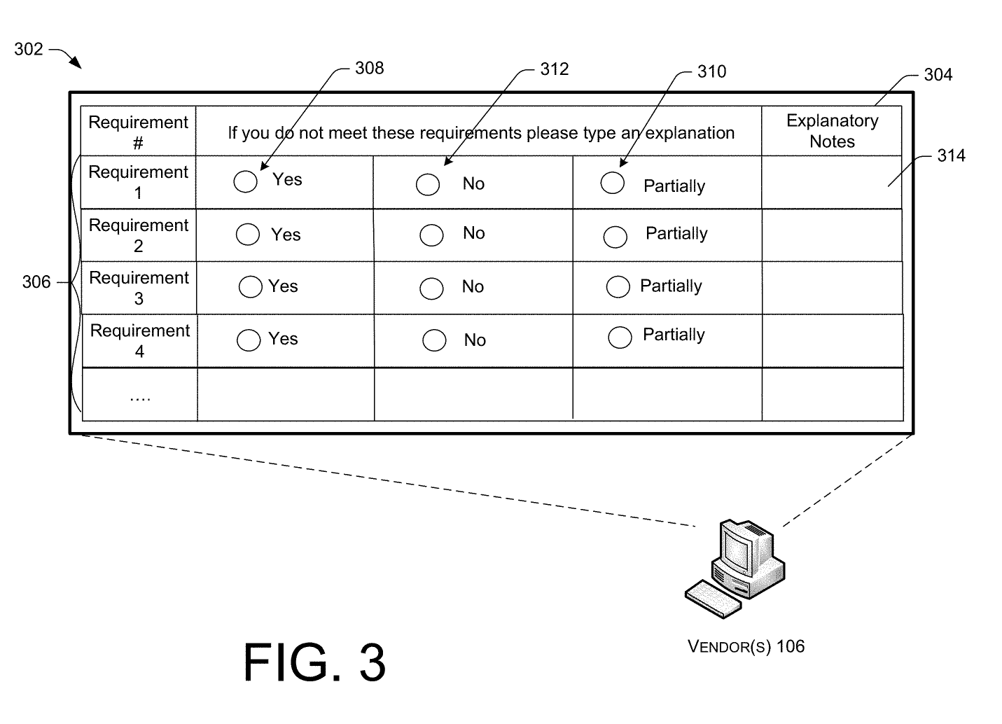

FIG. 3 illustrates an interface 302 that may enable a vendor to indicate whether they are able to fulfill a set of requirements specified by the requestor. For instance, once a requestor has specified which requirements they need for items, those requirements may be sent to multiple vendors. The vendors may view the requirements as shown in table 304 on the interface 302. The requirements may be displayed as a list as shown in list 306. The vendor may be asked to indicate if they are able to fulfill the requirement in full, partially full, or not at all, as shown by indication markers 308, 310, and 312, respectively. Additionally, the vendor may be presented an opportunity to provide an explanatory note for each requirement, as shown by box 314. These notes may provide details regarding fulfillment of a requirement, such as a reason why requirements cannot be fulfilled, details regarding an item that can be provided by a vendor to fulfill a requirement, and so on. Once each vendor has filled out their requirement fulfillment page, then that information can be provided to the acquisition service 104 to be sent to the requestor. For example, the information provided by the vendors may be provided to the requestor via the interface 240.

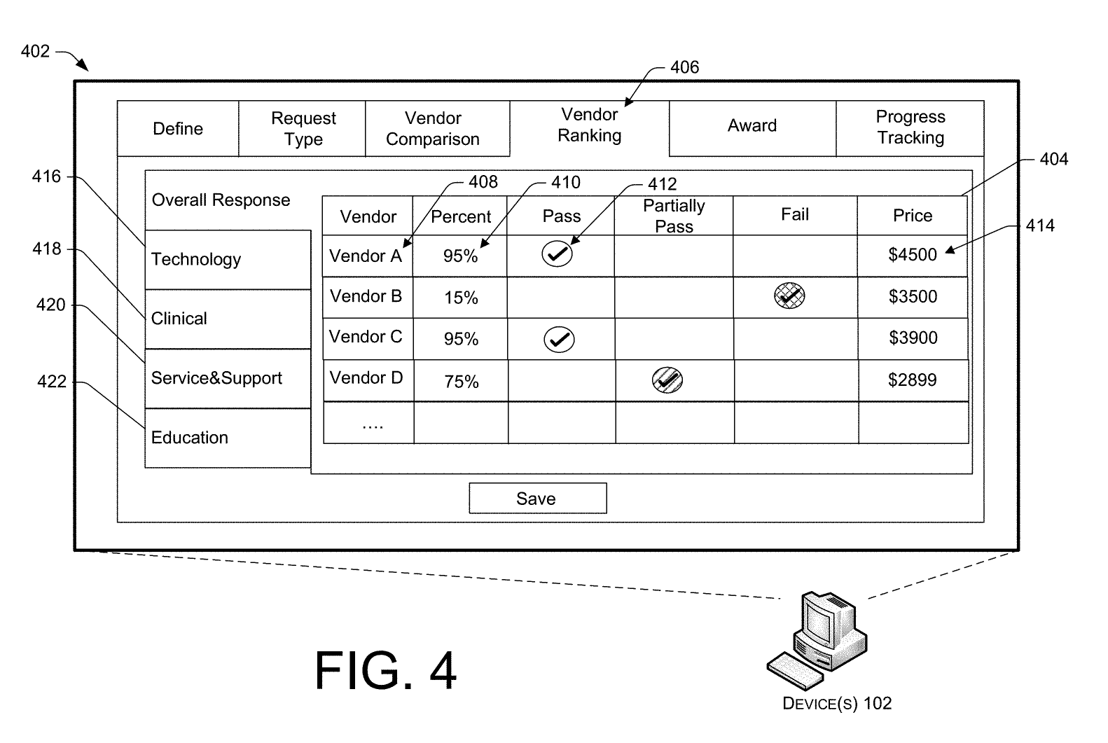

FIG. 4 illustrates an interface 402 that may enable a requestor to view a ranking of vendors based on the vendors' abilities to fulfill requirements indicated by the requestor. For example, the data processing module 126 may rank the vendors based on their ability to fulfill requirements, a bid price provided by the vendors, and/or a degree of importance (e.g., as indicated by the requestor). For instance, if Vendor A can fulfill more requirements than Vendor B, but Vendor A cannot fulfill any requirements with a high degree of importance, and Vendor B can fulfill requirements with a high degree of importance, Vendor B may be ranked higher than Vendor A. As shown in the interface 402, the ranking of the vendors may be provided via a table 404 under a vendor ranking tab 406. The vendors in the table 404 may or may not be listed in order based on their ranking. The requestor may be presented an overall response rank. As shown, the table 404 may present a percentage of fulfillment (e.g., vendor A—95%, vendor B—15%, etc.), ability ranking (pass, partially pass, or fail), and an overall price regarding each vendor. The percentage may indicate what percent of the requirements that the vendor is able to fulfill. The price may indicate the bid price provided by the vendor to fulfill requirements set forth by the requestor (e.g., a bid at which items are being offered for acquisition). The ability ranking markers indicate a level of fulfillment of requirements (e.g., a pass may be associated with fulfillment of a first threshold number of requirements, a partial pass may be associated with fulfillment of a second threshold number of requirements that is less than the first threshold number, and a fail may be associated with less than the second threshold number of requirements). The pass, partially passed, and fail markers may be color coded. For instance, a green indicator may represent passed, a yellow indicator may represent partially passed, and a red indicator may represent fail. In this example, Vendor A (408) has a 95% requirement fulfillment percentage 410, and is associated with a pass, shown by an indicator 412, with a bid price of $4,500, shown by a bid price 414.

Further, the interface 402 includes tabs 416-422 which provide the ability to view the vendors rank and ability to fulfill specific requirements (e.g., requirement of particular categories). For instance, if the requestor clicked on a technology tab 416 the requestor would be provided with a list of the requirements that the requestor previously specified regarding technology, as well as an indication for each vendor detailing an ability of the vendor to fulfill the requirements for technology.

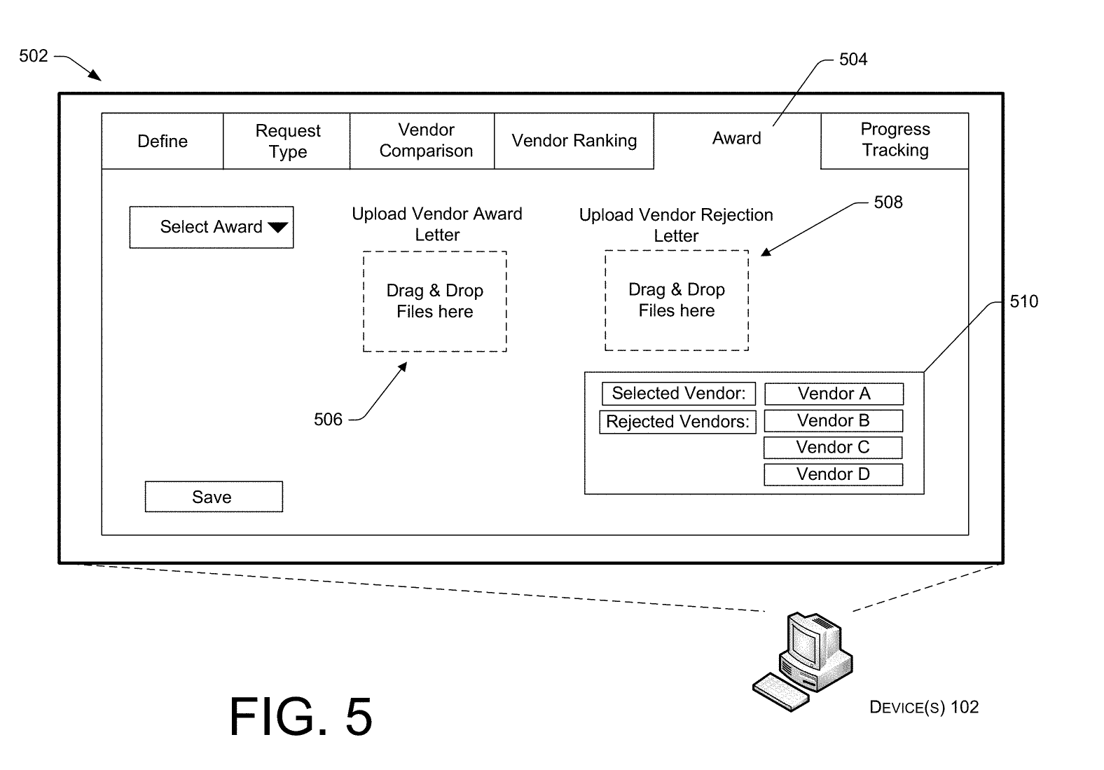

FIG. 5 illustrates an interface 502 that enables a requestor to select a vendor in which to award a purchase. The interface 502 may be presented under an award tab 504 and may include drag and drop boxes 506 and 508 for uploading a vendor award letter or vendor rejection letter, respectively. Additionally, there may be a table 510 that displays a list of the selected vendor and rejected vendors. Although a single vendor is shown as a selected vendor, in some instances multiple vendors may be selected for a final stage. For example, vendors that are able to satisfy a threshold number of requirements may be selected for further communications with a requestor (e.g., to get into further details regarding bids).

Although not illustrated in FIGS. 2-5, in some instances a progress tracking tab may be presented to enable a requestor to view the progress of a purchase (e.g., due dates, dates submitted), ask questions of vendors, and the like. For example, the progress tracking tab may display to a requestor a date that a vendor award letter was sent as well as an indication of when the items that the vendor is providing are expected to arrive.

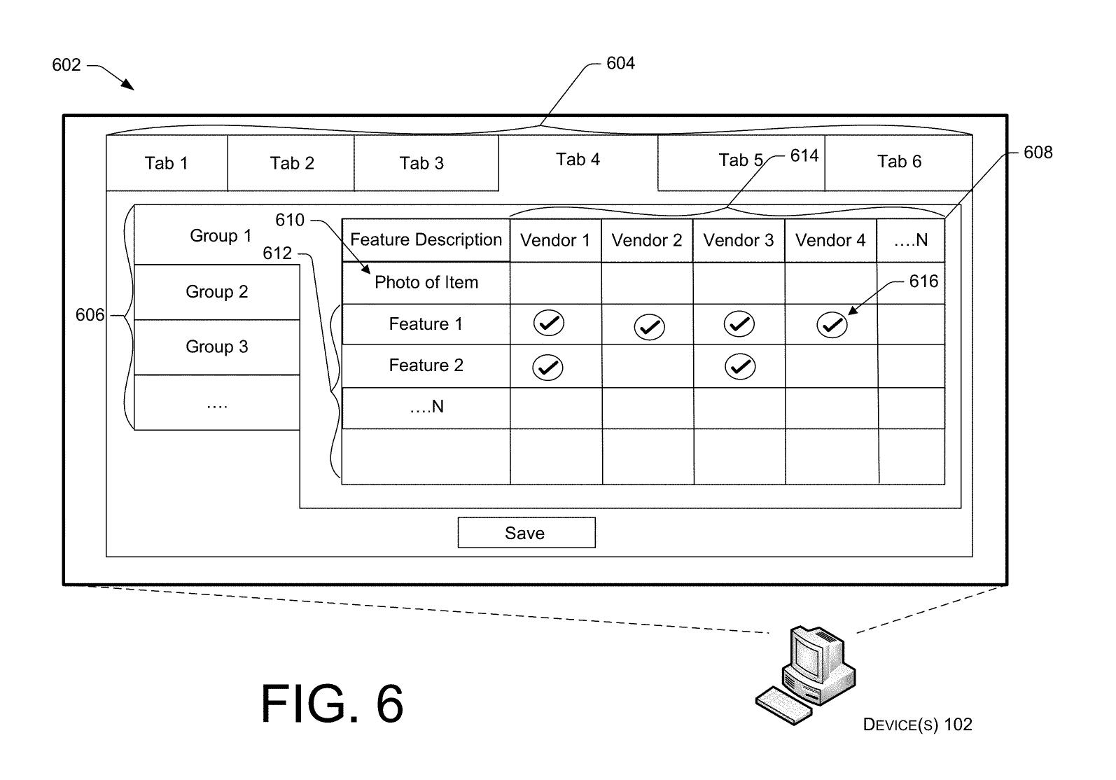

FIG. 6 illustrates an interface 602 that enables a requestor to view a vendor library. The vendor library provides an opportunity for a requestor to learn about items available for purchase and which vendors are offering those items for purchase. The information on the interface 602 may be provided to the acquisition service 104 from vendors. The information in the vendor library may be accessible via a series of tabs, such as tabs 604 and tabs 606. In some instances, the tabs 604 may correspond to a define tab, a request type tab, a vendor comparison tab, a vendor ranking tab, an award tab, and/or a progress tracking tab, similar to those discussed above in FIGS. 2-5. In this case, the selected tab (“Tab 4”) may be a vendor library tab. The tabs 606 may allow the requestor to access information regarding different items available for purchase (e.g., different categories of items). For instance, the tabs 606 may include information regarding telemetry items, large monitor items (e.g., computer monitors), compact monitor items, transport items, telemetry transmitters, telemetry systems, disclosure systems, and/or remote access systems. As an example, Group 1 may be large monitor items, Group 2 may be compact monitor items, and Group 3 may be telemetry transmitters. The table 608 may present information that is specific to an item 610. For example, the table 608 may display features 612 associated with the item 610, a list of a plurality of vendors 614, and an indication(s) 616 specifying which vendors are able to provide the features 612 for the item 610. As an example, if Group 1 in the tabs 606 related to large monitors, the table 608 may indicate (i) features specific to large monitors that are available for purchase, (ii) which vendors offer large monitors for acquisition, and/or (iii) which vendors offer which features for the large monitors.

Although the example of FIG. 6 discusses providing information regarding a vendor library to a requestor, in some instances such information may not be made available to the requestor. Rather, the information for the vendor library may be maintained by the acquisition service 104 to generate interfaces that more generally describe features that are available, such as the interface 202 of FIG. 2A.

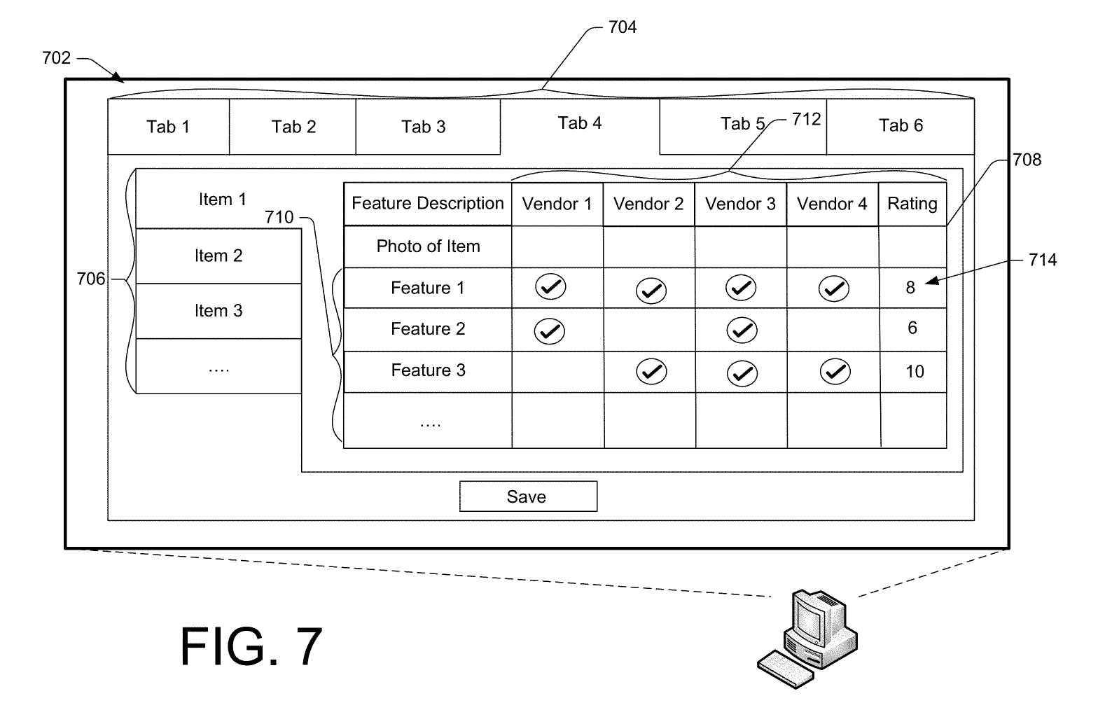

FIG. 7 illustrates an example interface 702 to enable users associated with the acquisition service 104 to enter and/or organize information regarding items available for purchase. In this example, users associated with the acquisition service 104 may submit information regarding items that are offered by vendors. Thereafter, the acquisition service 104 may use the information to generate various interfaces for requestors, vendors, and so on. For example, the information gathered through the interface 702 may be used by the acquisition service 104 to provide the interface 202 to a requestor to specify requirements in a request items. In another example, the information gathered through the interface 702 may be used to provide the interface 602 to a requestor to view a vendor library.

As illustrated in FIG. 7, the interface 702 may have a plurality of tabs 704 that correspond to a plurality of category of items available for purchase from a plurality of vendors. Within an individual tab, there may be additional tabs, such as tabs 706, which correspond to specific items within the category of item tabs. For instance, within a monitor tab (e.g., “Tab 4”), the more specific items may include large monitors, compact monitors, transport monitors, and the like. When an individual item is selected, table 708 may present a plurality of features 710 that correspond to the individual item. An individual associated with the acquisition service 104 may be enabled to enter information into the table 708 that indicates which vendors of the plurality of vendors 712 provide an item with the indicated features. Additionally, the individual associated with the acquisition service 104 may provide a rating for each item and/or feature indicating a level of importance for each item and/or feature, such as rating 714. Alternatively, or additionally, these ratings may be determined by the acquisition service 104, such as by populating the ratings based on ratings received from a plurality of requestors in the past. For instance, if a certain feature is always rated relatively high by requestors filling out a request, then that feature may automatically be rated relatively high in the interface 702. Furthermore, there may be an option on the interface 702 to add a row or column in the table 708 in order to add an additional feature or add an additional vendor. In some cases, a cell containing information regarding a certain feature may be expandable in order to enable the addition of more detailed data. For instance, when the information regarding a certain feature is too large to fit within a cell of the table 708, the cell can be expanded to add the additional information, and then be retracted so that the information cannot be viewed unless the feature is interacted with (e.g. clicked on, hovered over, etc.).

### Example Process

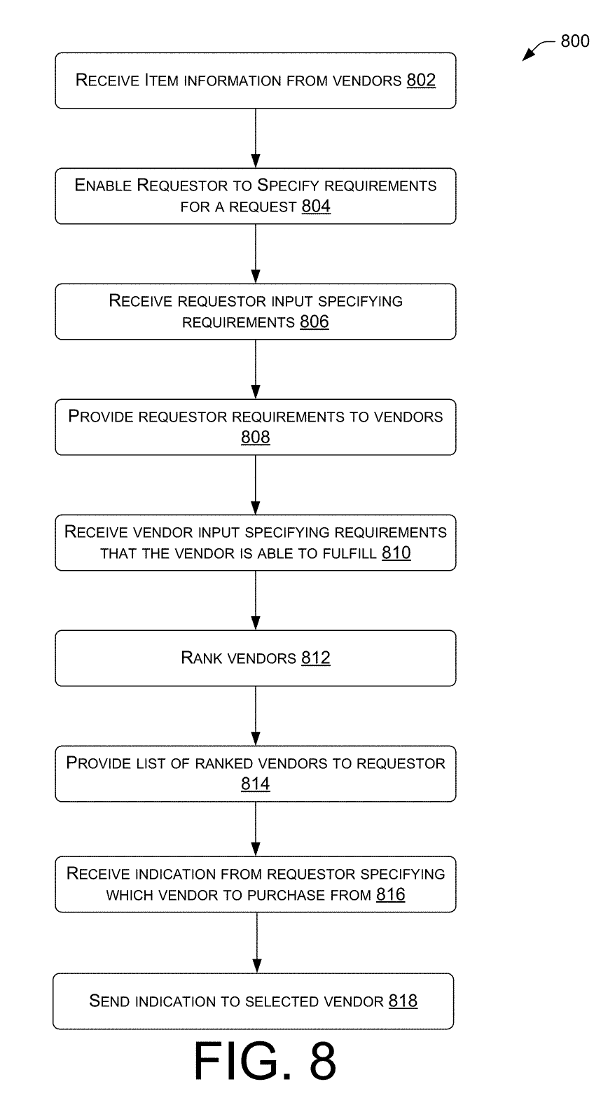

FIG. 8 illustrates example process 800 for employing the techniques described herein. For ease of illustration the process 800 is described as being performed in the architecture 100 of FIG. 1. For example, one or more of the individual operations of the process 800 may be performed by the device 102, the computing device associated with the vendor 106, and/or acquisition service 104. However, the process 800 may be performed in other architectures. Moreover, the architecture 100 may be used to perform other processes.

The process 800 (as well as each process described herein) is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any number of the individual operations may be omitted.

FIG. 8 illustrates the example process 800 to enable a requestor to select a vendor for fulfilling requirements of the requestor for items. In this example, the process 800 is described as being performed by the acquisition service 104.

At 802, the acquisition service 104 may receive item information from a vendor regarding details of items available for acquisition (e.g., specifications of equipment available for purchase). For instance, the vendor 106 may inform the acquisition service 104 that they have telemetry devices, large monitor devices, compact monitor devices, transport monitor devices, telemetry transmitter devices, telemetry systems, remote access systems, and the like available for purchase. Each of these items may have different specifications that the vendor 106 may provide to the acquisition service 104. To illustrate, the item information or the features available for telemetry devices may include, device name, waveform views, bad lead indicators, remote print buttons, pacemaker detection, pacemaker rejection, dimensions, weight, display size, color display, ECG display, waterproof, defibrillation detection, battery type, battery life, charge time, battery status indicator, bands available, hot swap channel repair, supported sensors, diagnostic 12 lead, arrhythmia analysis QT and ST segment analysis, real-time waveform on transmitter, audible alarms, and the like. As another illustration, the specification information or the features available for the monitoring devise may include, device name, multi-parameter modules, additional module support, screen size, touchscreen, bedside PC, trends at bedside, 3rd party device integration, configurable alarms, configurable views, modes (adult, pediatric, and neonate), patient data transfer, remote access of patient data, barcoding, release date, projected end-of-life, ECG, respirations, dual SPO2, NIBP, Temperature, invasive pressure, cardiac output, ETCO2, EEG, hemodynamic calculations, drug dose calculations, and the like. The information received from the vendor 106 may be stored in the vendor data store 132. Alternatively, or additionally, operation 802 may include receiving information from other sources, such as from individuals associated with the acquisition service 104 (e.g., through the interface 702), from vendors' websites (e.g., automatically scrapping websites), etc.

At 804, the acquisition service 104 may enable the requestor to specify requirements for a request. For example, the acquisition service 104 may provide an interface (e.g., the interface 110) via the device 102 with options to specify requirements for acquiring items. In one example, this may include displaying the interface 202 of FIG. 2A. In some instances, the options that are provided are based on items and features of the items that are available from vendors (e.g., based on the item information received at 802). In some instances, this information is received through the interface 702. Further, in some instances various tabs may be presented via the interface to enable requirements to be specified for various categories of items/features. For instance, the interface may provide a networking tab, server tab, security tab, interfacing tab, remote access tab, test environment tab, project management tab, and so on. Additionally, in some instances the interface may provide the requestor 108 with access to a vendor library, which displays details (e.g., features, specifications, etc.) regarding items that are available from vendors and which vendors can supply which items.

At 806, the acquisition service 104 may receive requestor input specifying requirements for acquiring items (e.g., requirements of the requestor 108 for items). For instance, through the device 102 and the interface 202, the requestor 108 may indicate which items and/or features of items they are interested in purchasing. As one example, the requestor 108 may indicate what features they would like included, without necessarily specifying which item they would like to purchase. Additionally, or alternatively, for each requirement, the requestor may indicate a degree of importance. For instance, when indicating networking requirements, as shown in FIG. 2A, if having a proprietary LAN hard wired network is important to a requestor, the requestor may give that requirement an “8” (on a scale of 1-10, with 10 being the most important). Whereas, if a proprietary LAN wireless network is not important, the requestor may give that requirement a “2.”

At 808, the acquisition service 104 may provide requirements received from a requestor to vendors. For example, the acquisition service 104 may provide an interface (e.g., the interface 302 of FIG. 3) to a vendor to enable the vendor to specify an ability to fulfill requirements.

At 810, the acquisition service may receive input from a vendor(s) specifying which requirements the vendor(s) is able to fulfill. For instance, the interface 302 may be provided to the vendor 106. The vendor 106 can then specify if they can fulfill the requirement, they cannot fulfill the requirement, or if they can partially fulfill the requirement. Additionally, or alternatively, the vendors 106 may be provided with a section to provide an explanatory note. Further, the vendor 106 may specify a price at which requirements may be fulfilled (e.g., a bid price at which items are offered that satisfy the requirements).

At 812, the acquisition service 106 may rank vendors based on their ability to fulfill the requirements, a degree of importance of requirements (e.g., as indicated by a requestor, set by the acquisition service 104, learned overtime, etc.), and/or the bid price received from the vendors.

At 814, the acquisition service 104 may provide a list of the ranked vendors to a requestor. As one example, the list may include, as shown in FIG. 4, an overall response section listing each vendor, each vendor's percent of the requirements they are able to fulfill, a pass, partially pass, or fail indication, and/or the bid price provided by the vendor. Additionally, or alternatively, other information may be displayed regarding individual requirements and/or an indication of which vendors are able to fulfill those requirements.

At 816, the acquisition service 104 may receive an indication from a requestor specifying which vendor the requestor would like to purchase items from. As one example, a vendor may select a vendor and upload a vendor award letter to be sent to the vendor. In some instances, the requestor may additionally, or alternatively, upload a vendor rejection letter to be sent to a vendor that has not been selected.

At 818, the acquisition service 104 may send an indication to a selected vendor (e.g., a device associated with the selected vendor) indicating an intent of a requestor to acquire items from the selected vendor.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method comprising:
providing, by a computing device, a first interface to enable a requestor to specify a set of requirements of the requestor for acquiring items;
receiving, by the computing device and via the first interface, requestor input specifying the set of requirements for acquiring items;
providing, by the computing device, a second interface to enable individual ones of a plurality of vendors to indicate an ability to fulfill the set of requirements;
receiving, via the second interface and from individual ones of the plurality of vendors, vendor data indicating a number of requirements of the set of requirements that the respective vendor is able to fulfill and indicating a price at which the items are offered for acquisition to the requestor;
ranking, by the computing device, the plurality of vendors based at least in part on vendor data for each of the plurality of vendors;
providing, by the computing device, information to a device associated with the requestor, the information including a list of the plurality of vendors that is based at least in part on the ranking;
receiving, by the computing device, an indication from the requestor selecting a vendor of the plurality of vendors; and
sending, by the computing device, an indication to a device associated with the selected vendor indicating an intent of the requestor to acquire the items from the selected vendor.

2. The method of claim 1, wherein the first interface includes a plurality of sections associated with a plurality of requirement categories, respectively, and the first interface includes a progress indication that specifies a level of progress toward completing requirements for the plurality of requirement categories.

3. The method of claim 2, wherein the progress indication includes a color for a section of the plurality of sections to indicate a level of progress toward completing requirements in the associated requirement category for the section.

4. The method of claim 1, wherein the first interface comprises a plurality of sections, and the method further comprises:
enabling an individual to access individual sections of the plurality of sections based at least in part on a level of access that is granted to the individual.

5. The method of claim 4, wherein the first interface further provides an indication specifying which requirements of the set of requirements that the individual is allowed to specify based at least in part on the level of access that is granted to the individual.

6. The method of claim 1, wherein the information that is provided to the device that is associated with the requestor includes a list of the set of requirements and an ability of at least one vendor of the plurality of vendors to fulfill each of the set of requirements.

7. The method of claim 1, wherein the requestor input further specifies a degree of importance for each requirement of the set of requirements; and wherein ranking the plurality of vendors is based at least in part on the degree of importance for each requirement of the set of requirements.

8. The method of claim 1, further comprising:
receiving, from at least one of the plurality of vendors, information regarding details of items that are offered for acquisition by the at least one vendor;
wherein the first interface includes a set of options that are based at least in part on the information regarding details of the items that are offered for acquisition by the at least one vendor.

9. One or more computer-readable storage media storing computer-readable instructions that, when executed, instruct one or more processors to perform operations comprising:
providing a requestor interface via a device associated with a requestor;
receiving, via the requestor interface, requestor input specifying a set of requirements for acquiring items;
providing a vendor interface via a device associated with a vendor, the vendor interface providing information regarding the set of requirements;
receiving, via the vendor interface, vendor data indicating a number of requirements of the set of requirements that a vendor is able to fulfill;
providing, via the requestor interface, information indicating the number of requirements of the set of requirements that the vendor is able to fulfill;
receiving an indication from the requestor selecting the vendor; and
sending an indication to the device associated with the vendor indicating an intent of the requestor to acquire items from the vendor.

10. The one or more computer-readable storage media of claim 9, wherein the requestor interface includes a plurality of sections associated with a plurality of requirement categories, respectively, and the requestor interface includes a progress indication that specifies a level of progress toward completing requirements for the plurality of requirement categories.

11. The one or more computer-readable storage media of claim 9, wherein the information indicating the number of requirements of the set of requirements that the vendor is able to fulfill comprises a percentage of the number of requirements that the vendor is able to fulfill, and/or an indication of pass, partially pass, or fail regarding the number of requirements that the vendor is able to fulfill.

12. The one or more computer-readable storage media of claim 9, wherein the operations further comprise:
based at least in part on previous bids from previous vendors, calculating an estimated price for acquiring items that satisfy the set of requirements; and
sending the estimated price to the device associated with the requestor.

13. The one or more computer-readable storage media of claim 12, wherein the operations further comprise:
providing a suggestion to change a particular requirement of the set of requirements to reduce the estimated price for acquiring the items that satisfy the set of requirements, the suggestion indicating a reduced price for acquiring the items that satisfy the set of requirements.

14. The one or more computer-readable storage media of claim 9, wherein the operations further comprise:
sending a communication to a device associated with another vendor that was not selected by the requestor, the communication indicating that the other vendor was not selected to fulfill the set of requirements.

15. A system comprising:
one or more processors; and
memory coupled to the one or more processors and storing instructions that, when executed, instruct the one or more processors to perform operations comprising:
receiving specification information from a plurality of vendors, the specification information including details of items that are offered for acquisition by the plurality of vendors;
providing a requestor interface to enable a requestor to select a set of requirements of the requestor for acquiring items, at least one of the requirements of the set of requirements being based at least in part on the specification information;
receiving, via the requestor interface, requestor input specifying a set of requirements for acquiring items;
receiving vendor data indicating a number of requirements of the set of requirements that a particular vendor of the plurality of vendors is able to fulfill; and
providing, via the requestor interface, information that indicates the number of requirements of the set of requirements that the particular vendor is able to fulfill.

16. The system of claim 15, wherein the requestor interface includes a plurality of sections associated with a plurality of requirement categories, respectively, and the requestor interface includes a progress indication that specifies a level of progress toward completing requirements for the plurality of requirement categories.

17. The system of claim 16, wherein the progress indication includes a color for a section of the plurality of sections to indicate a level of progress toward completing requirements in the associated requirement category for the section.

18. The system of claim 15, wherein the operations further comprise:
based at least in part on previous bids from previous vendors, calculating an estimated price for acquiring items that satisfy the set of requirements; and
sending the estimated price to a device associated with the requestor.

19. The system of claim 18, wherein the operations further comprise:
providing a suggestion to change a particular requirement of the set of requirements to reduce the estimated price for acquiring the items that satisfy the set of requirements, the suggestion indicating a reduced price for acquiring the items that satisfy the set of requirements.

20. The system of claim 15, wherein the requestor input further specifies a degree of importance for each requirement of the set of requirements; and the operations further comprise:
ranking the plurality of vendors based at least in part on the degree of importance for each requirement of the set of requirements.
